(19) United States
(12) Patent Application Publication
(10) Pub. No.: US 2025/0227405 A1
(43) Pub. Date: Jul. 10, 2025

(54) BONE CONDUCTION HEADPHONES WITH PUSH TO TALK FEATURE

(71) Applicant: WEAVIX, INC., Wichita, KS (US)

(72) Inventors: Kevin TURPIN, Wichita, KS (US); Benjamin BURRUS, Wichita, KS (US)

(21) Appl. No.: 19/013,933

(22) Filed: Jan. 8, 2025

Related U.S. Application Data
(60) Provisional application No. 63/619,045, filed on Jan. 9, 2024.

(51) Int. Cl. H04R 1/10

(52) U.S. Cl. CPC H04R 1/1041; H04R 1/1025; H04R 1/105; H04R 2460/13

(57) ABSTRACT

A headphone apparatus and methods of operation for bone conduction headphones with push-to-talk operation is disclosed. The headphone apparatus is capable of wireless communication and can be communicatively coupled to one or more machines. The push-to-talk feature of the headphone apparatus enables transmissions/messages from the headphone apparatus to the one or more communicatively coupled machines. The push-to-talk feature of the headphone apparatus can also enable push-to-talk operation of the one or more communicatively coupled machines. The headphone apparatus is configured to be received by a charging case. The charging case is configured to enable wireless charging and/or wired charging of the headphone. The charging case is configured to be received by a charging cradle.

### CROSS-REFERENCE TO RELATED APPLICATION

This application claims priority to U.S. Provisional Application No. 63/619,045, titled “BONE CONDUCTION HEADPHONES WITH PUSH TO TALK FEATURE,” and filed Jan. 9, 2024, which is incorporated by reference herein in its entirety.

### TECHNICAL FIELD

The present disclosure is generally related to headphone apparatuses and methods of operating the same.

### BACKGROUND

Coordinating multiple frontline workers in large, intricate facilities with complex machinery presents dynamic inspection and maintenance challenges. Communication challenges in industrial environments are often compounded by the unavailability of many conventional communication devices, such as smartphones, tablets, or portable computers on site. This can be particularly problematic when there is an emergency and multiple groups need to be alerted in a rapid, reliable, and flexible manner. Traditional methods and systems for communication within, and monitoring of, manufacturing and construction facilities sometimes fail to overcome the reliability, rapidity, and flexibility challenges of a dynamic industrial work environment.

### BRIEF DESCRIPTION OF THE DRAWINGS

FIG. 1 is a drawing of an example headphone apparatus in accordance with one or more embodiments.

FIG. 2 is a drawing of an example placement of a headphone apparatus on or about an ear in accordance with one or more embodiments.

FIG. 3 is an illustration of a headphone apparatus communicatively coupled to one or more machine in accordance with one or more embodiments.

FIGS. 4A-4B are drawings of an example charging case for a headphone apparatus in accordance with one or more embodiments.

FIGS. 5A-5B are drawings of an example charging cradle for one or more charging cases in accordance with one or more embodiments.

FIG. 6 is a flow diagram providing an example method of operation of a headphone apparatus in accordance with one or more embodiments.

FIG. 7 is a flow diagram providing an example method of operation of a headphone apparatus in accordance with one or more embodiments.

FIG. 8 is a flow diagram providing an example method of charging a headphone apparatus in accordance with one or more embodiments.

FIG. 9 is a block diagram illustrating an example computer system, in accordance with one or more embodiments.

### DETAILED DESCRIPTION

The embodiments disclosed herein describe a bone conduction headphone apparatus and methods of operating the same. Construction, manufacturing, repair, utility, resource extraction and generation, and healthcare industries, among others, rely on real-time monitoring and tracking of frontline workers, individuals, inventory, and assets such as infrastructure and equipment. This gives rise to a need for reliable, flexible tools to facilitate rapid communication. The present invention is a wireless bone conduction headphone apparatus with a button configured to enable push-to-talk (PTT) operation.

The advantages and benefits of the headphone apparatus and methods disclosed herein include solutions for reliable, flexible communication tools and methods that provide users the ability to take advantage of PTT functionality in a multitude of dynamic work environments. For example, depending on the conditions of the work environment, frontline workers may need the ability to communicate alarms or emergency situations while wearing bulky or unwieldy hand protection that makes operating a radio device difficult. As another example, work conditions and maintenance requirements may necessitate frontline workers to operate in confined spaces that may restrict the ability to access a radio device in a pocket or on a belt. In an additional example, an emergency situation may necessitate a frontline worker simultaneously operating machinery or attending to personnel while also communicating aspects of the emergency situation to others. Flexible, reliable communication tools and methods are needed to address these challenges.

A further advantage of the present technology includes a solution to sanitation challenges that arise from sharing communication equipment. For example, working environments that include shift work may necessitate that a single set of communication equipment be transferred from one set of shift personnel to a second set of shift personnel, giving rise to sanitation challenges.

Yet another advantage includes a solution to charging and pairing challenges that come with wireless devices. For example, working conditions may necessitate that multiple sets of headphones be distributed to a large group of frontline workers. Distributing many sets of headphones creates challenges in managing the integrity of each individual set of headphones and creates difficulties in keeping each set of headphones charged in an organized manner.

The button on the headphone apparatus, when depressed, enables local audio signals (e.g., voice transmissions/messages of a user of the headphone apparatus) to be received (i.e., captured) and sent (i.e., transmitted) to one or more machines that are communicatively coupled to the headphone apparatus. Embodiments disclosed herein provide that when the PTT button is depressed, PTT operation is enabled on one or more communicatively coupled machines. Some embodiments of the bone conduction headphone apparatus are operated as a pair. For example, a user may wear one of the apparatuses on or about the left ear, and one of the apparatuses on or about the right ear. In some embodiments where a pair of headphone apparatuses are employed, the PTT button on the left headphone apparatus enables PTT operation on one or both of the left and right headphone apparatuses, or vice versa. The headphone apparatus is configured to be received by a charging case that facilitates charging of the apparatus through wireless charging, wired charging, or both. The charging case is configured to be received by a charging cradle. In some embodiments, the charging cradle is configured to receive a plurality of charging cases.

In some embodiments, PTT operation of the headphone apparatus is enabled via operation of one or more machines. For example, the headphone apparatus can be configured such that PTT operation of the headphone apparatus is enabled by depressing a PTT button of the one or more machines. That is, by depressing the PTT button on the one or more machines, the headphone apparatus is enabled to capture and transmit local audio signals. This can allow, for example, more efficient/easier communication in certain front line environments where a worker's hands may be unable to access the PTT button of the headphone apparatus, but can otherwise access the PTT button of a radio device on the worker's belt.

The headphone apparatus of claim 1 wherein the headphone apparatus is configured to be communicatively coupled to one or more machines, the one or more machines including PTT functionality and configured to be worn by the user, and wherein the one or more machines are configured to enable PTT operation of the headphone apparatus such that depressing a button of the one or more machines enables local audio capture and transmission by the headphone apparatus.

Embodiments of the present disclosure will be described more thoroughly from now on with reference to the accompanying drawings. Like numerals represent like elements throughout the several figures, and in which example embodiments are shown. However, embodiments of the examples are embodied in many different forms and should not be construed as limited to the embodiments set forth herein. The examples set forth herein are non-limiting examples and are merely examples, among other possible examples. Throughout this specification, plural instances (e.g., “224”) implement components, operations, or structures (e.g., “224a”) described as a single instance. Further, plural instances (e.g., “224”) refer collectively to a set of components, operations, or structures (e.g., “224a”) described as a single instance. The description of a single component (e.g., “224a”) applies equally to a like-numbered component (e.g., “224b”) unless indicated otherwise. These and other aspects, features, and implementations are expressed as methods, apparatuses, systems, components, program products, means, or steps for performing a function, and in other ways. These and other aspects, features, and implementations will become apparent from the following sections, including the examples. Any of the embodiments described in each section can be used with one another and features of each embodiment are not necessarily exclusive to the described embodiment such that the headings are not limiting.

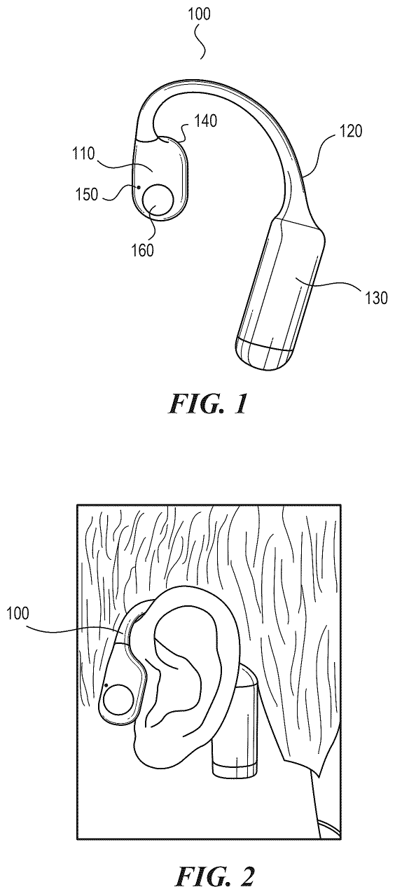

Turning to FIGS. 1 and 2, FIG. 1 is a drawing of an example headphone apparatus in accordance with one or more embodiments. FIG. 2 is a drawing of an example placement of a headphone apparatus on or about an ear in accordance with one or more embodiments. The headphone apparatus 100 is comprised of a speaker housing 110 on one end of the apparatus 100, a circuit housing 130 on an end opposite the speaker housing 110, and a curved ear hook 120 that connects the speaker housing 110 and the circuit housing 130. The ear hook 120 is used to position the headphone apparatus 100 on or about the ear, for example as illustrated in FIG. 2.

The speaker housing 110 is comprised of a bone conduction speaker 140, a microphone 150, and a push-to-talk (PTT) button 160. The microphone 150 and/or PTT button 160 are positioned on the speaker housing 110 such that they are on a side and/or surface opposite the bone conduction speaker 140. Although only one headphone apparatus 100 is shown in FIG. 1, it should be understood that in an actual physical embodiment, multiple (e.g., a left headphone apparatus and a right headphone apparatus) are utilized such that the headphone apparatus 100 can adequately receive and transmit audio and data signals.

The bone conduction speaker 140 is configured to transmit sound to an inner ear of a user primarily through the bones of the skull without covering the user's ear canal. Examples of a bone conduction speaker 140 are formed from one or more piezoelectric transducers that convert electrical signals received from electronic circuits in the circuit housing 130 to vibrations. The bone conduction speaker 140 then passes these vibrations to the inner ear of the user. In some embodiments, the bone conduction speaker 140 has an output around 105 dB to be loud enough to be heard by a worker in a noisy facility. The bone conduction speaker 140 adjusts to ambient noise, for example, the headphone apparatus 100 or a circuit driving the bone conduction speaker 140 samples the ambient noise, and then increases a volume of the output audio from the bone conduction speaker 140 such that the volume is greater than the ambient noise (e.g., 5 dB louder). The microphone 150 receives spoken sounds from the user and transmits signals representative of the sounds to the electronic circuits in the circuit housing 130 for processing.

Bone conduction headphones are particularly useful in work settings that involve multiple users interchanging headphones on a regular (e.g., daily) basis because bone conduction headphones are not placed in the ear. Thus, bone conduction headphones do not require the same degree of cleaning as headphones that are placed in the ear. Furthermore, headphones that are placed in the ear can make it difficult to hear ambient sounds such as horns, sirens, or communication from other people, while bone conduction headphones do not physically interfere with ambient sounds.

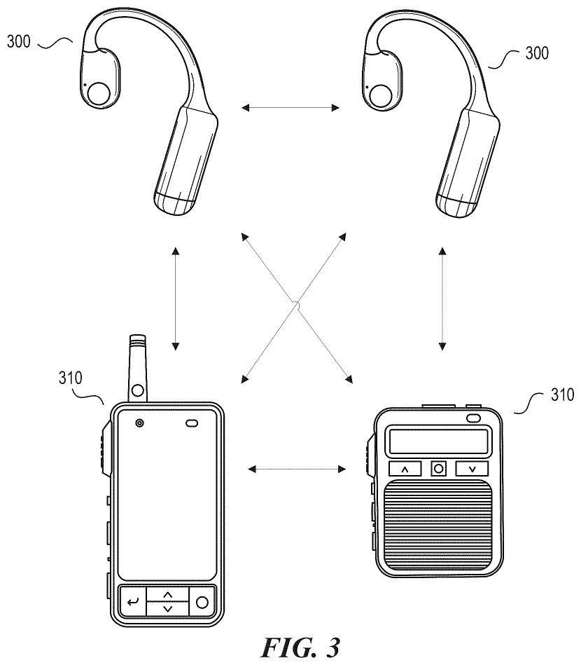

The PTT button 160, when depressed and/or pressed, enables local audio capture (e.g., voice transmissions/messages of a user/wearer of the headphone apparatus 100) to be sent to one or more machines that are communicatively coupled to the headphone apparatus 100 (e.g., the one or more machines 310 illustrated and described in more detail with reference to FIG. 3). In some embodiments, the PTT button 160, when depressed, also enables PTT operation of one or more machines that are communicatively coupled to the headphone apparatus 100. For example, depressing the PTT button 160 can cause electronic circuits in the circuit housing 130 to generate and transmit a command signal to the one or more machines that enables PTT operation of the one or more machines (as long as they are configured with PTT functionality). Thus, depressing the PTT button 160 on the headphone apparatus 100 can enable local audio signal capture and transmission by the one or more machines. Electronic circuits in the circuit housing 130 enable signals from the PTT button 160 to result in the desired function. The electronic circuits in the circuit housing 130 contain one or more wireless subsystems, processors, control circuits, power supplies, and additional circuitry. As used herein, the wireless subsystems include any wireless technologies used by the headphone apparatus 100 to communicate wirelessly (e.g., via radio waves) with one or more machines (e.g., radio devices).

FIG. 3 is an illustration of a headphone apparatus communicatively coupled with one or more machines in accordance with one or more embodiments. The headphone apparatus 300 communicatively couples with one or more machines 310. In some embodiments, multiple headphone apparatuses 300 are communicatively coupled.

In some embodiments, the headphone apparatus 300 contains one or more wireless subsystems that facilitate communicative coupling with one or more machines 310. In some embodiments, the wireless subsystems also facilitate communicative coupling, data connectivity, and data sharing across multiple headphone apparatuses 300. The wireless subsystems are each configured to transmit/receive data in an appropriate format, for example, in IEEE 902.11, 902.15, 902.16 Wi-Fi standards, Bluetooth standard, WinnForum Spectrum Access System (SAS) test specification (WINNF-TS-0065), and across a desired range. In some embodiments the wireless subsystems communicate employing a custom protocol in a predetermined wireless band or channel(s).

In some embodiments, the headphone apparatus 300 may make use of short-range machine-to-machine communication techniques, such as Bluetooth or Bluetooth Low Energy (BLE). A BLE communication is a beacon that is receivable by any machine configured to receive BLE communications (e.g., a smart apparatus) within range (adjustable by signal strength). A Bluetooth communication operates based on a pairing relationship between the smart apparatus and wireless transceiver apparatus of the machine. The relevant range is predetermined and based on settings that correspond to the method of detection.

The one or more machines 310 may include smart devices, such as smart radios, smart speakers, smart phones, or other smart devices, including smart devices configured to operate using Radio over Internet Protocol (RoIP).

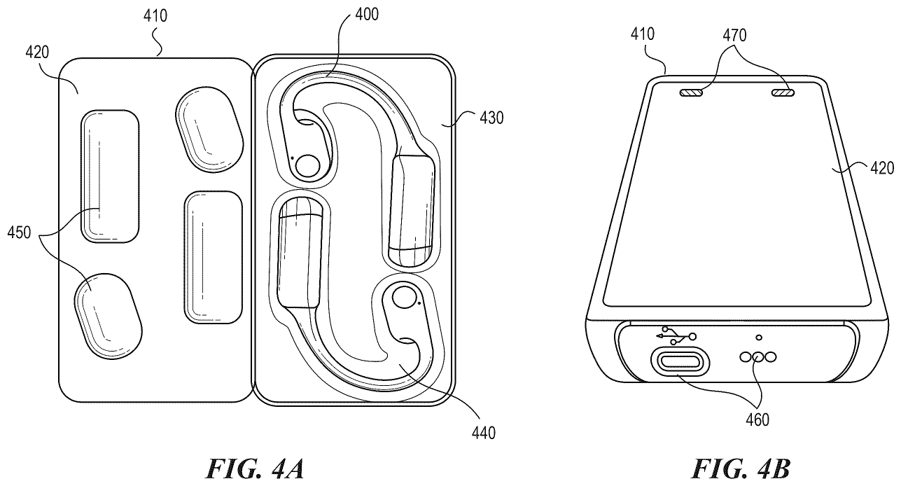

FIGS. 4A-4B are drawings of an example charging case for a headphone apparatus in accordance with one or more embodiments. The headphone apparatus 400 is configured to be received by a charging case 410 to facilitate charging of the headphone apparatus 400. The charging case 410 is configured to receive multiple headphone apparatuses 400 (e.g., a left headphone apparatus and a right headphone apparatus). The charging case 410 is comprised of a lid 420 and a body portion 430. In some embodiments the charging case 410 is configured with main receptacles 440 and lid receptacles 450, positioned in the body portion 430 and lid 420 respectively. The main receptacles 440 and lid receptacles 450 can be configured to accommodate either a single headphone apparatus, or multiple headphone apparatuses 400. When the headphone apparatus 400 is positioned in one of the main receptacles 440 of the charging case 410, the lid 420 is capable of being closed. The position of the lid receptacles 450 with respect to the main receptacles 440 is such that placement of the headphone apparatus 400 in the main receptacles 440 can still result in closing of the lid 420.

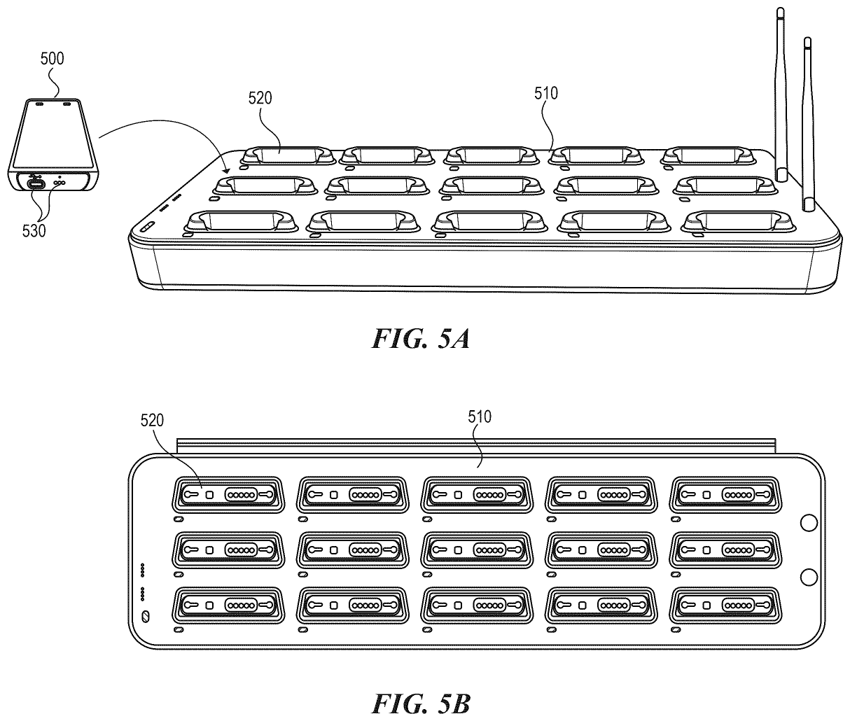

The charging case 410 is configured to facilitate charging of the headphone apparatus 400 through wireless charging, wired charging, or both. The charging case 410 is configured to receive an external power source (not shown in FIGS. 4A-4B) through one or more charging ports 460. For example, the external power source may be provided through a USB-C cable. In some embodiments the charging case 410 passes the power supply source directly to the headphone apparatus 400 by providing a contact path from the external power source through the charging ports 460 to the headphone apparatus. In some embodiments the charging case 410 is configured to allow the headphone apparatus 400 to charge through wireless charging. In some embodiments the charging case 410 is configured to be received by a charging cradle 510 (discussed in more detail in FIGS. 5A-5B). In additional embodiments the lid 420 of the charging case 410 includes one or more charging indicator lights 470 to provide indication of charge status of the headphone apparatus 400.

FIGS. 5A-5B are drawings of an example charging cradle for one or more charging cases in accordance with one or more embodiments. One or more charging cases 500 are configured to be received by a charging cradle 510. The charging cradle 510 is comprised of one or more cradle receptacles 520 which receive the one or more charging cases 500. In some embodiments, the charging cradle 510 is configured to provide a power supply source to the charging case 500. In some embodiments, the charging cradle 510 provides a wireless charging power supply source for the headphone apparatus in the charging case 500. In some embodiments, the charging cradle 510 provides a power supply source (e.g., a rechargeable battery) to the charging case 500 by connecting to the charging case 500 charging ports 530.

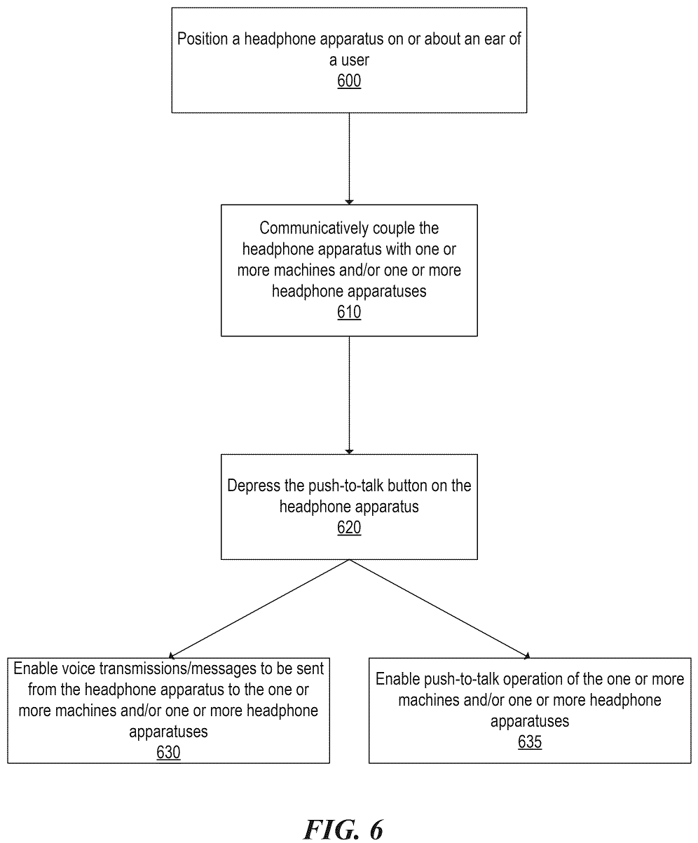

FIG. 6 is a flow diagram providing an example method of operation of a headphone apparatus in accordance with one or more embodiments. In step 600, a headphone apparatus is positioned on or about an ear of a user. In step 610, the headphone apparatus is communicatively coupled with one or more machines and/or one or more additional headphone apparatuses. For example, the headphone apparatus is pairable with one or more smart radios and/or one or more headphone apparatuses through a Bluetooth or Bluetooth Low Energy (BLE) connection, or suitable other machine-to-machine communication technique known in the art. In step 620, a push-to-talk (PTT) button on the headphone apparatus is depressed. In step 630, when the PTT button is depressed, voice transmissions/messages are enabled to be sent from the headphone apparatus to the one or more machines and/or the one or more headphone apparatuses that were communicatively coupled to the headphone apparatus in step 610. For example, the user is enabled to send voice transmissions/messages from the headphone apparatus to one or more smart radios and/or one or more additional headphone apparatuses.

In step 635, PTT operation is enabled in one or more machines and/or one or more headphone apparatuses in response to depressing the PTT button on the headphone apparatus as performed in step 620. When PTT operation is enabled in one or more machines and/or one or more headphone apparatuses, as performed in step 635, the user is enabled to send voice transmissions/messages from the one or more machines and/or one or more headphone apparatuses that were communicatively coupled to the headphone apparatus in step 610. For example, when the PTT button on the headphone apparatus is depressed, the user is enabled to send voice transmissions/messages from one or more smart radios and/or one or more headphone apparatuses that are communicatively coupled to the headphone apparatus. In some embodiments, when a PTT button on a first headphone apparatus on or about a user's left ear is depressed, the user is enabled to send voice transmissions/messages from a second headphone apparatus on or about the user's right ear (or vice versa), in addition to being enabled to send voice transmissions/messages from one or more smart radios.

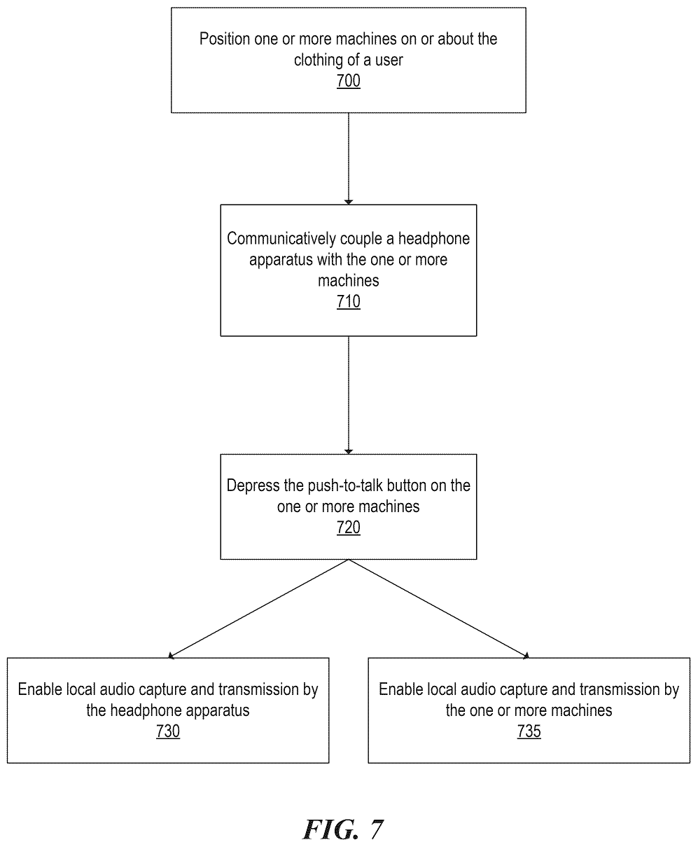

FIG. 7 is a flow diagram providing an example method of operation of a headphone apparatus in accordance with one or more embodiments. In step 700, one or more machines (e.g., radio devices) are positioned on or about a user (e.g., worn on the clothing and/or utility belt). In some embodiments, the one or more machines are configured with PTT functionality such that depressing a PTT button of the one or more machines enables local audio capture and transmission by the one or more machines.

In step 710, a headphone apparatus (e.g., any of the headphone apparatuses disclosed throughout this document) is communicatively coupled with the one or more machines. For example, the headphone apparatus is pairable with one or more smart radios and/or one or more headphone apparatuses through a Bluetooth or Bluetooth Low Energy (BLE) connection, or suitable other machine-to-machine communication technique known in the art.

In step 720, the PTT button on the one or more machines is depressed. In step 730, when the PTT button is depressed, local audio signals (e.g., voice transmissions/messages of the user wearing the one or more machines and/or headphone apparatus) are enabled to be sent and received by the headphone apparatus. For example, depressing the PTT button on the one or more machines can send a command signal to the headphone apparatus paired with the one or more machines, causing PTT operation of the headphone apparatus to initiate. That is, the command signal enables local audio capture and transmission by the headphone apparatus. In some embodiments, electronic processing circuitry in a circuit housing of the headphone apparatus actuates PTT operation upon receipt of the command signal.

In step 735, PTT operation is enabled by the one or more machines in response to depressing the PTT button on the one or more machines. In some embodiments, depressing the PTT button on the one or more machines enables both PTT operation of the one or more machines and PTT operation of the headphone apparatus.

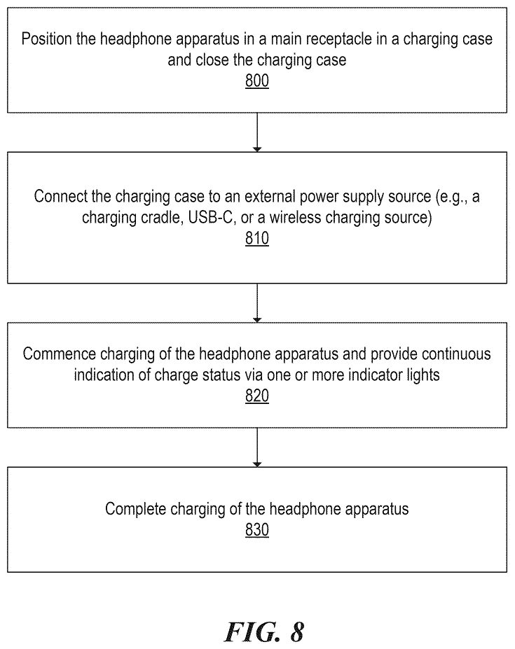

FIG. 8 is a flow diagram providing an example method of charging a headphone apparatus in accordance with one or more embodiments. In step 800, a headphone apparatus is positioned in the main receptacle in a charging case and the charging case is closed. In step 810, the charging case is connected to an external power supply source (e.g., the charging case is connected to a charging cradle, connected directly to a USB-C cable, or placed near a wireless charging source). In step 820, the headphone apparatus commences charging and an indicator light on the lid of the charging case provides continuous indication of charge status of the headphone apparatus. In step 830, the headphone apparatus continues charging until fully charged or removed from the external power supply source.

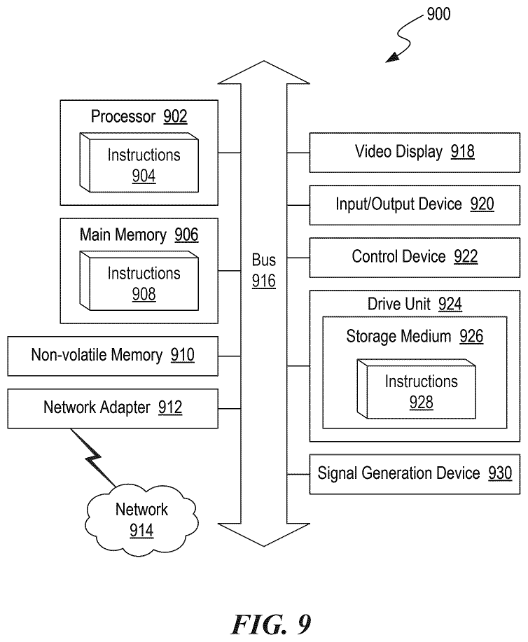

FIG. 9 is a block diagram illustrating an example computer system, in accordance with one or more embodiments. Components of the example computer system 900 are used to implement the headphone apparatus 100, illustrated and described in more detail with reference to FIGS. 1-8. At least some operations described herein are implemented on the computer system 900.

The computer system 900 includes one or more central processing units (“processors”) 902, main memory 906, non-volatile memory 910, network adapters 912 (e.g., network interface), video displays 918, input/output devices 920, control devices 922 (e.g., keyboard and pointing devices), drive units 924 including a storage medium 926, and a signal generation device 930 that are communicatively connected to a bus 916. The bus 916 is illustrated as an abstraction that represents one or more physical buses and/or point-to-point connections that are connected by appropriate bridges, adapters, or controllers. In embodiments, the bus 916, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an IEEE standard 1394 bus (also referred to as “Firewire”).

In embodiments, the computer system 900 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 900.

While the main memory 906, non-volatile memory 910, and storage medium 926 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 928. The term “machine-readable medium” and “storage medium” shall also be taken to include any medium that is capable of storing, encoding, or carrying a set of instructions for execution by the computer system 900.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 904, 908, 928) set at various times in various memory and storage devices in a computer device. When read and executed by the one or more processors 902, the instruction(s) cause the computer system 900 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 910, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 912 enables the computer system 900 to mediate data in a network 914 with an entity that is external to the computer system 900 through any communication protocol supported by the computer system 900 and the external entity. In embodiments, the network adapter 912 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 912 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. For example, one will recognize that “memory” is one form of a “storage” and that the terms are on occasion used interchangeably.

Consequently, alternative language and synonyms are used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A headphone apparatus comprising:
a speaker housing at a first section of the headphone apparatus, the speaker housing including:
a bone conduction speaker on a first side of the speaker housing;
a microphone; and
a button on a second side of the speaker housing opposite the first side, the button configured to enable push-to-talk (PTT) operation of the headphone apparatus such that depressing the button enables local audio capture and transmission by the headphone apparatus; and
a circuit housing at a second section of the headphone apparatus different from the first section;
wherein the headphone apparatus is configured to be worn on an ear of a user.

2. The headphone apparatus of claim 1 wherein the headphone apparatus is configured to be communicatively coupled to one or more machines, the one or more machines including PTT functionality and configured to be worn by the user, and wherein the button of the speaker housing is configured to enable PTT operation of the one or more machines such that depressing the button enables local audio capture and transmission by the one or more machines.

3. The headphone apparatus of claim 2 wherein at least one of the one or more machines is a radio device.

4. The headphone apparatus of claim 1 wherein the headphone apparatus is configured to be communicatively coupled to one or more machines, the one or more machines including PTT functionality and configured to be worn by the user, and wherein the one or more machines are configured to enable PTT operation of the headphone apparatus such that depressing a button of the one or more machines enables local audio capture and transmission by the headphone apparatus.

5. The headphone apparatus of claim 1 wherein the headphone apparatus is a first headphone apparatus configured to be worn on a first side of the user's head, and wherein the button of the speaker housing of the first headphone apparatus is configured to enable PTT operation of a second headphone apparatus configured to be worn on a second side of the user's head different from the first side, wherein depressing the button of the speaker housing of the first headphone apparatus enables local audio capture and transmission by the second headphone apparatus.

6. The headphone apparatus of claim 1 wherein the microphone is positioned on a first surface of the speaker housing and the bone conduction speaker is positioned on a second surface of the speaker housing opposite the first surface.

7. The headphone apparatus of claim 1, further comprising a curved section coupling the speaker housing to the circuit housing, wherein the curved section is configured to be positioned on the ear of the user.

8. The headphone apparatus of claim 1, wherein the headphone apparatus is configured to be charged via placement in a charging case.

9. A push-to-talk (PTT) system comprising:
a first headphone apparatus configured to be worn on a first side of a user's head, the first headphone apparatus including:
a speaker housing at a first section of the first headphone apparatus, the speaker housing including:
a bone conduction speaker on a first side of the speaker housing;
a microphone; and
a first button on a second side of the speaker housing opposite the first side; and
a circuit housing at a second section of the first headphone apparatus different from the first section;
a second headphone apparatus configured to be worn on a second side of the user's head different from the first side; and
a machine communicatively coupled to at least one of the first and second headphone apparatuses, the machine including a second button;
wherein the first button of the first headphone apparatus is configured to enable PTT operation of at least one of the first and second headphone apparatuses such that depressing the first button enables local audio capture and transmission by at least one of the first and second headphone apparatuses; and
wherein the second button of the machine is configured to enable PTT operation of the machine such that depressing the second button enables local audio capture and transmission by the machine.

10. The PTT system of claim 9 wherein the first button of the first headphone apparatus is configured to enable PTT operation of the machine such that depressing the first button enables local audio capture and transmission by the machine.

11. The PTT system of claim 10 wherein the machine is a radio device.

12. The PTT system of claim 9 wherein the second button of the machine is configured to enable PTT operation of at least one of the first and second headphone apparatuses such that depressing the second button enables local audio capture and transmission by at least one of the first and second headphone apparatuses.

13. The PTT system of claim 9 wherein the microphone is positioned on a first surface of the speaker housing and the bone conduction speaker is positioned on a second surface of the speaker housing opposite the first surface.

14. The PTT system of claim 9, further comprising a charging case, wherein the first and second headphone apparatuses are configured to be received by the charging case.

15. The PTT system of claim 14, further comprising a charging cradle, wherein the charging case is configured to be received by the charging cradle, and wherein the charging cradle is configured to receive multiple charging cases.

16. A method comprising:
positioning a headphone apparatus about an ear of a user, the headphone apparatus including a bone conduction speaker on a first side of the headphone apparatus and a button on a second side of the headphone apparatus opposite the first side, the button configured to enable push-to-talk (PTT) operation of the headphone apparatus;
communicatively coupling the headphone apparatus with one or more machines, the one or more machines including PTT functionality and configured to be worn by the user;
depressing the button on the headphone apparatus; and
enabling local audio capture and transmission thereof from the headphone apparatus to the one or more machines based on depressing the button on the headphone apparatus.

17. The method of claim 16, further comprising enabling local audio capture and transmission thereof from the one or more machines based on depressing the button on the headphone apparatus.

18. The method of claim 16 wherein the headphone apparatus is a first headphone apparatus, and wherein the method further comprises:
communicatively coupling the first headphone apparatus with a second headphone apparatus; and
enabling local audio capture and transmission thereof from the second headphone apparatus based on depressing the button on the first headphone apparatus.

19. The method of claim 16 wherein the button of the headphone apparatus is a first button and the one or more machines includes a second button, and wherein the method further comprises enabling local audio capture and transmission thereof from the headphone apparatus based on depressing the second button of the one or more machines.

20. The method of claim 16 further comprising charging the headphone apparatus via a charging cradle configured to receive multiple headphone apparatuses.
